(19) United States
(12) Patent Application Publication
(10) Pub. No.: US 2017/0201532 A1
(43) Pub. Date: Jul. 13, 2017

(54) BLACK MARKET COLLECTION METHOD FOR TRACING DISTRIBUTORS OF MOBILE MALWARE

(71) Applicant: KOREA INTERNET & SECURITY AGENCY, Seoul (KR)

(72) Inventors: Woong GO, Seoul (KR); Eun Young CHOI, Seoul (KR); Mi Joo KIM, Seoul (KR); Tae Jin LEE, Seoul (KR)

(21) Appl. No.: 15/006,419

(22) Filed: Jan. 26, 2016

(30) Foreign Application Priority Data
Jan. 7, 2016 (KR) 10-2016-0002296

(51) Int. Cl. H04L 29/06

(52) U.S. Cl. CPC H04L 63/1416; H04L 63/20

(57) ABSTRACT

A black market collection system for tracing distributors of mobile malware comprises: a black market collection module for collecting web sites suspected to be a black market or apk files suspected to be a black market app by a search related to black markets through portal sites, and creating a URL list of the collected web sites suspected to be a black market; an app static analysis module for obtaining a source code by decompiling the collected apk file and detecting a URL of a site address distributing a corresponding app; a site analysis module for collecting apk files by analyzing the URL or each URL pattern of thereof and creating an apk collection pattern rule related to paths of collecting the apk files; and a database for storing the URL list of the collected web sites suspected to be a black market and the created apk collection pattern rule.

### CROSS REFERENCE TO RELATED APPLICATION

The present application claims the benefit of Korean Patent Application No. 10-2016-0002296 filed in the Korean Intellectual Property Office on Jan. 7, 2016, the entire contents of which are incorporated herein by reference.

### BACKGROUND OF THE INVENTION

Field of the Invention

The present invention relates to black markets which distribute mobile malware, and more specifically, to a black market collection method for tracing distributors of mobile malware.

Background of the Related Art

Recently, users of mobile terminal increase rapidly. The reason why the users of mobile terminal increase is that the users may use the Internet without constraints of time and space and promote friendship through a service such as SNS. In addition, it is since that conveniences of many people, such as using financial services, issuing free service coupons and the like, are provided through a simple procedure.

The mobile terminals are called as smart phones as high-performance hardware resources and a high-level operating system are mounted, and they provide fast Internet service together with convenient functions through a variety of apps, exceeding the level of a simple communication device limited only to communication functions.

Recently, as the users of mobile terminal increase rapidly and IT techniques are advanced, the smart phones mounting high-performance hardware resources and a high-level operating system obtained a name of smart phone exceeding the level of a simple communication device and provide fast Internet service together with convenient functions through a variety of apps.

With the advent of smart phones, users may access the Internet regardless time and space and use various services, and life patterns of the users face various changes. Only by installing a desired mobile app in a smart phone, the users are allowed to play a game, manage a schedule, process of a business work or perform a financial transaction, as well as performing simple Internet searches.

As such a variety of mobile apps are installed in the smart phones, cases of distributing mobile malware also increase rapidly.

The mobile malware leaks information stored in a smart phone to attackers at regular time intervals or performs a malicious behavior such as deleting the stored information. In addition, the mobile malware performs a malicious behavior according to a command of a remote server in some cases.

Although countermeasures of detecting and blocking the mobile malware are properly carried out in a normal mobile app market through a detection system possessed by the normal mobile app market, users of the other environments are not protected from the risk of mobile malware. Particularly, the mobile malware can be easily spread in an unreliable distribution environment such as a black market.

In August 2012, a security company TrustGo analyzed that mobile malware ‘SMSZombie’ distributed from GFAN, which is the largest black market in China, infected about 500,000 smart phones only in China.

In addition, a mobile malware having a diagnostic name of ‘Geinimi’ disguised as a general game program to persuaded users to install the malware. Other than this, a plurality of apps such as ‘Monkey Jump 2’, ‘President vs. Aliens’ and the like are modified as a malicious app and distributed through the black market. The black markets are frequently used to illegally use normal apps.

In the black market, attackers repackage paid apps and distribute them for free. If an attacker inserts a code performing a malicious behavior in the process of repackaging a paid app and distributes the app, users doubtlessly install the repackaged app and are damaged by the app.

Therefore, although it needs to block such black markets and recommend to use normal markets, since a large number of black markets are easily created and deleted and URLs of the black markets can be frequently changed, it is not easy to keep an eye on and monitor the black markets.

### SUMMARY OF THE INVENTION

Therefore, the present invention has been made in view of the above problems, and it is an object of the present invention to provide a black market collection method for tracing distributors of mobile malware, which actively traces URLs and detects black markets mainly distributing the mobile malware.

Additional features and advantages of the present invention will be described below and partially will be apparent from the description or learned by practice of the present invention. The objectives and other advantages of the present invention will be implemented in particular by means of the structure pointed out in the claims as well as the description described below and added drawings.

The present invention implements a black market site collection system for determining a black market site by analyzing URLs expected to be a market site or apk files expected to be a market app based on a search result obtained through portal sites (e.g., Google, Naver, Daum and the like).

The present invention proposes a technique of collecting black markets based on search keywords. Through the black market site collection method, the present invention is expected to collect black markets and continuously monitor whether or not malware is distributed.

To accomplish the above object, according to one aspect of the present invention, there is provided a black market site collection system related to a black market collection system for tracing distributors of mobile malware.

The black market collection system includes: a black market collection module for collecting web sites suspected to be a black market or apk files suspected to be a black market app by means of a search related to black markets through portal sites, and creating a URL list of the collected web sites suspected to be a black market; an app static analysis module for obtaining a source code by decompiling the collected apk file and detecting a URL of a site address distributing a corresponding app; a site analysis module for collecting apk files by analyzing the URLs detected by the app static analysis module or each URL pattern of the URL list and creating an apk collection pattern rule related to paths of collecting the apk files; and a database for storing the URL list of the collected web sites suspected to be a black market and the created apk collection pattern rule.

Preferably, the app static analysis module includes: a decompiler for obtaining the source code by decompiling the collected apk file; a string detection unit for detecting a string of a site address distributing the apk file from the source code; and a regular expression unit for creating a URL address of a corresponding site by combining the detected string.

Preferably, the site analysis module includes: a URL pattern analysis unit for visiting a corresponding web site according to the URL of the collected web site suspected to be a black market and searching, in steps, a structure of an app market site configured in order of a category level, an app information list level and an app download level through an HTML analysis; a URL history creation unit for creating a path history reaching a current level when the search does not reach the ‘app download’ level yet as a result of the search performed by the URL pattern analysis unit; an apk collection unit for downloading a corresponding app if it is determined that the search of the URL pattern analysis unit has reached the ‘app download’ level as a result of the search; and a collection pattern rule creation unit for creating a rule related to an apk collection pattern with reference to the path history if it is determined that the search of the URL pattern analysis unit has reached the ‘app download’ level.

To accomplish the above object, according to another aspect of the present invention, there is provided a black market site collection method related to a black market collection method for tracing distributors of mobile malware, the method including the steps of: collecting web sites suspected to be a black market or apk files suspected to be a black market app by means of a search related to black markets through portal sites; creating a URL list of the collected web sites suspected to be a black market; detecting a URL of a site address distributing a corresponding app by performing a static analysis on the collected apk file, by an app static analysis module; collecting apk files by analyzing the URLs detected by the app static analysis module or each URL pattern of the URL list, by a site analysis module; creating an apk collection pattern rule related to a path of collecting the apk file; and storing the URL list of the collected web sites suspected to be a black market and the created apk collection pattern rule in a database.

### BRIEF DESCRIPTION OF THE DRAWINGS

FIG. 1 is a block diagram showing a black market collection system according to the present invention.

FIG. 2A is a block diagram showing an app static analysis module according to the present invention.

FIG. 2B is a block diagram showing a site analysis module according to the present invention.

FIG. 3 is a flowchart illustrating a black market collection method according to the present invention.

FIG. 4 is an exemplary view showing the operation of a black market collection module according to the present invention.

FIG. 5 is an exemplary view showing the operation of detecting URL information by parsing a search result of portal sites according to the present invention.

FIG. 6 is a view showing a table of a URL list according to the present invention.

FIG. 7 is an exemplary view showing a pattern analysis using ‘div class’ tag of the present invention.

FIG. 8 is an exemplary view showing a pattern analysis using ‘a class’ tag of the present invention.

FIG. 9 is an exemplary view showing a procedure of creating an apk collection pattern rule according to the present invention.

FIG. 10 is a view showing an apk collection pattern rule of each black market group.

DESCRIPTION OF SYMBOLS

| | |
|---|---|
| 100: Black market collection module | |
| 200: App static analysis module | |
| 210: Decompiler | 220: String detection unit |
| 230: Regular expression unit | 300: Site analysis module |
| 310: URL pattern analysis unit | 320: Apk collection unit |
| 330: URL history creation unit | |
| 340: Collection pattern rule creation unit | |
| 400: Database | |

### DETAILED DESCRIPTION OF THE PREFERRED EMBODIMENT

The preferred embodiments of the present invention will be described in detail with reference to the accompanying drawings so that those skilled in the art can easily implement the present invention. In the drawings, like numbers refer to the same or similar functionality throughout the several views.

The present invention implements a black market site collection system for determining a black market by analyzing URLs expected to be a market site or apk files expected to be a market app based on a search result obtained through portal sites (e.g., Google, Naver, Daum and the like).

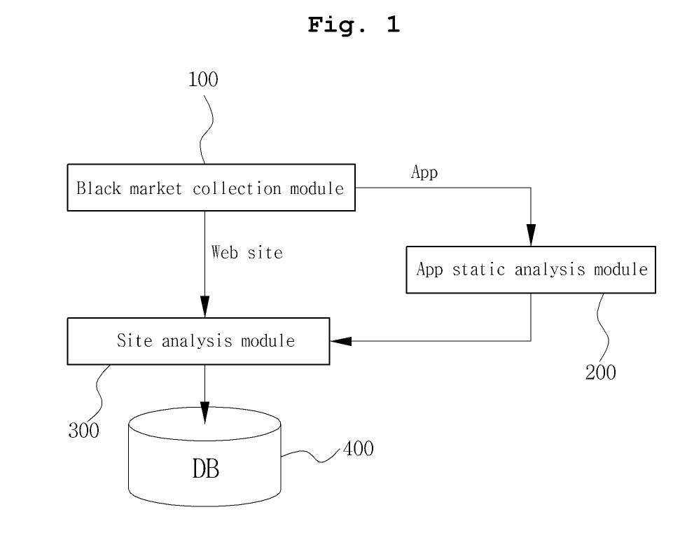

FIG. 1 is a block diagram showing a black market collection system according to the present invention.

As shown in FIG. 1, a black market collection system according to the present invention is configured to include a black market collection module 100, an app static analysis module 200, a site analysis module 300 and a database 400 to trace distributors of mobile malware.

The black market collection module 100 collects web sites suspected to be a black market or apk files suspected to be a black market app by means of a search related to the black market through portal sites. Then, the black market collection module 100 creates a URL list of the collected web sites suspected to be a black market.

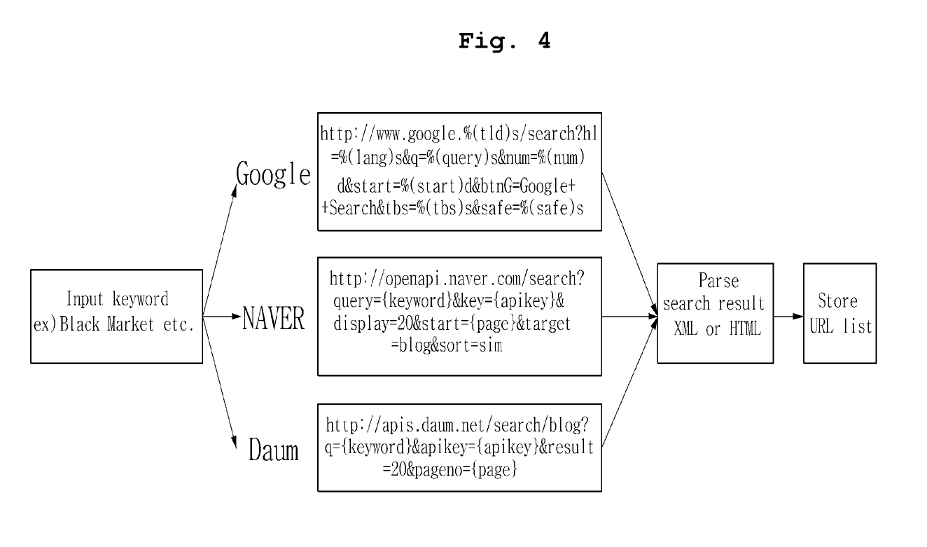

When the black market sites are collected, the black market collection module 100 uses an Open API provided by the portal sites as shown in FIG. 4. If a user inputs a search keyword related to the black market sites through the Open API of the portal sites and a search result according thereto is output, the black market collection module 100 parses the search result and stores information on the Uniform Resource Locator (URL) list as shown in FIG. 4. FIG. 4 is an exemplary view showing the operation of a black market collection module according to the present invention.

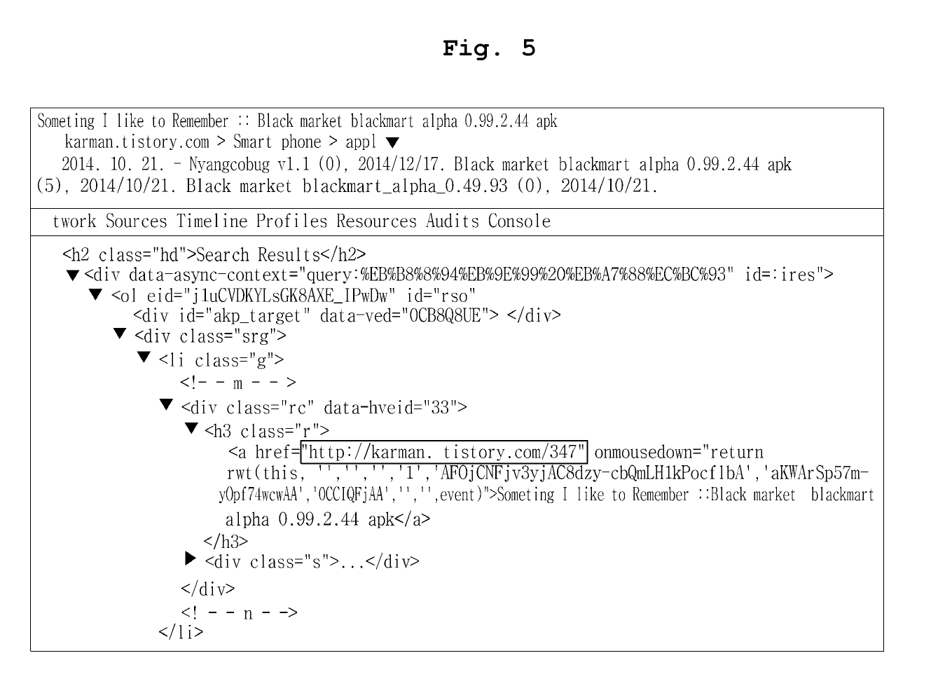

FIG. 5 is an exemplary view showing the operation of detecting URL information by parsing a search result of portal sites according to the present invention.

As shown in FIG. 5, the black market collection module 100 extracts URLs of blogs related to an app suspected to be a black market by performing HTML parsing on a search result of a portal site (e.g., Google).

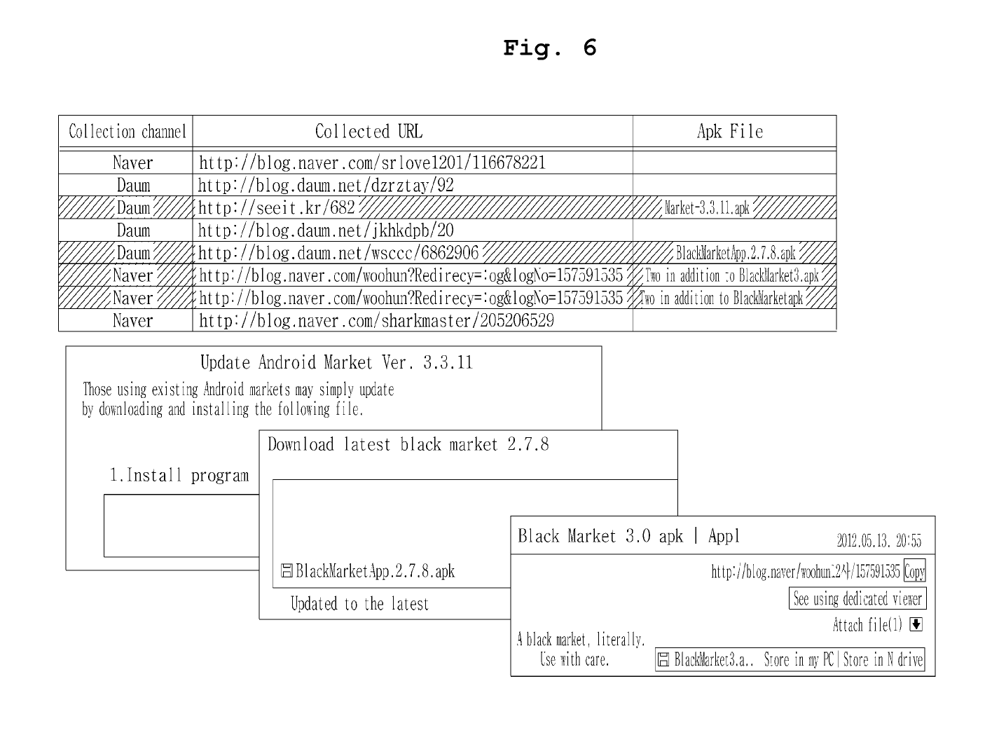

FIG. 6 is a view showing a table of a URL list according to the present invention.

As shown FIG. 6, the present invention collects web sites suspected to be a black market or apps suspected to be a black market (e.g., apk files) through the Open API of various portal sites such as Google, Naver, Daum and the like and creates a URL list of the collected web sites suspected to be a black market.

If a specific apk file exists in the URLs secured through the search of the black market collection module 100, the app static analysis module 200 derives URL information by performing a static analysis on the corresponding apk file. The app static analysis module 200 obtains a source code by decompiling the apk file and detects a URL of a site distributing a corresponding app.

The site analysis module 300 collects apk files by analyzing the URLs detected by the app static analysis module or each URL pattern of the URL list and creates an apk collection pattern rule related to the paths of collecting the apk files.

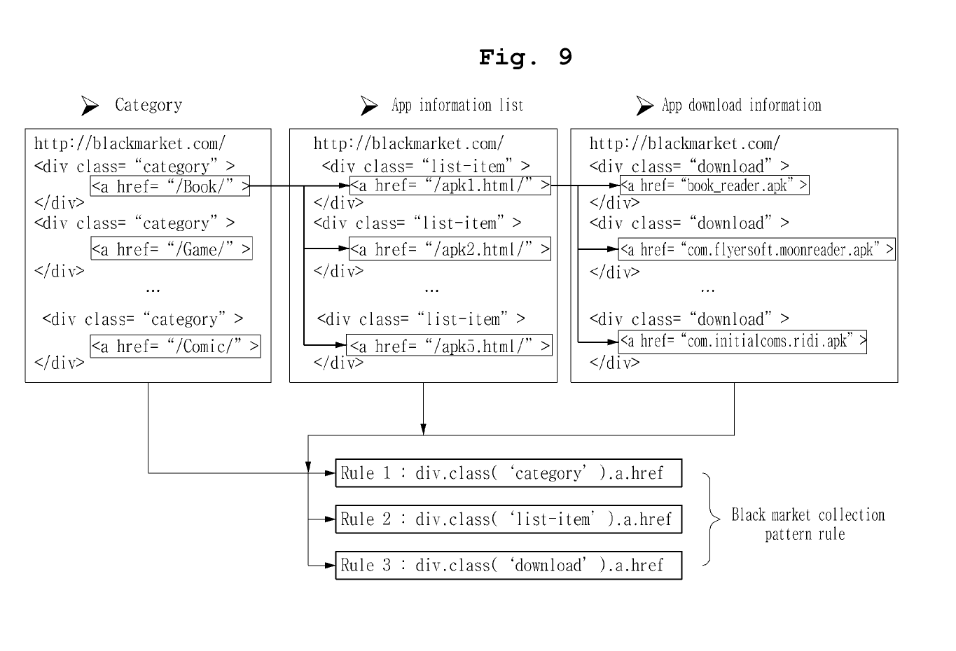

A web site suspected to be a black market generally has a site structure which forms three types of pages in steps, i.e., a category level, an app information list level and an app download level, as shown in FIG. 9.

When the levels (e.g., the category level, the app information list level and the app download level) are classified as shown in FIG. 9, the site analysis module 300 analyzes linked URLs through various forms of tags (e.g., ‘div class’, ‘a class’ and the like) and finally grasps existence of an apk file. FIG. 9 is an exemplary view showing a procedure of creating an apk collection pattern rule according to the present invention.

Like this, when web sites suspected to be a black market have a structural feature (or a pattern) peculiar to a black market, the present invention determines a corresponding site as a black market.

The database 400 stores the URL list of the collected web sites suspected to be a black market and the created apk collection pattern rule.

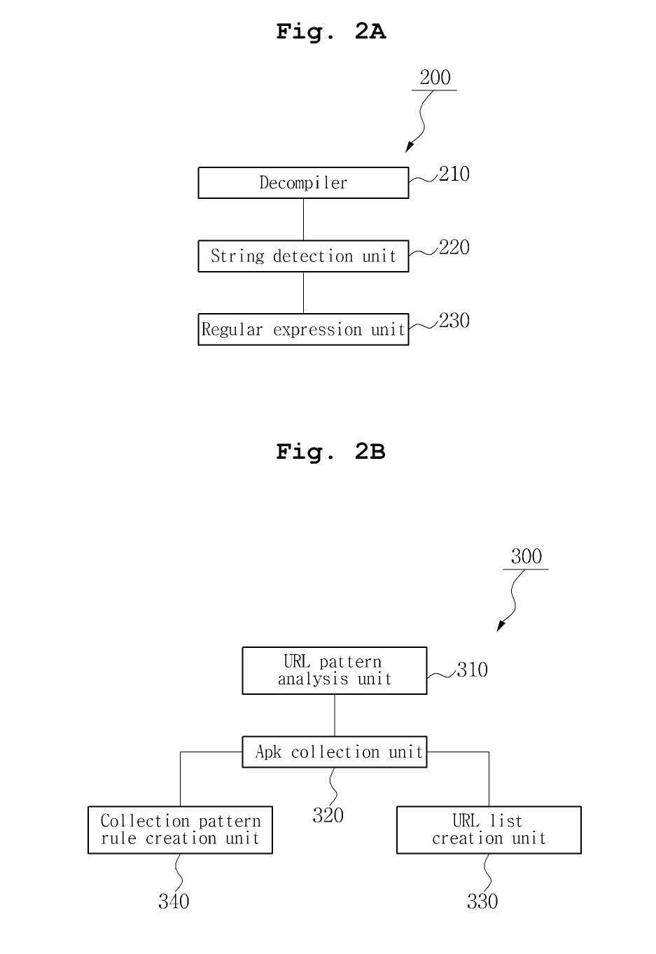

FIG. 2A is a block diagram showing an app static analysis module according to the present invention.

As shown in FIG. 2A, the app static analysis module 200 according to the present invention is configured to include a decompiler 210, a string detection unit 220 and a regular expression unit 230.

The decompiler 210 converts the binary code of the collected apk file into a source code by performing decompilation.

The string detection unit 220 detects a string of a site address distributing the apk file from the converted source code.

The regular expression unit 230 creates a URL address of a corresponding site by reconfiguring the detected string into a form conforming to the URL format.

FIG. 2B is a block diagram showing a site analysis module according to the present invention.

As shown in FIG. 2B, the site analysis module 300 is configured to include a URL pattern analysis unit 310, an apk collection unit 320, a URL history creation unit 330 and a collection pattern rule creation unit 340.

The URL pattern analysis unit 310 visits a corresponding web site according to the URL of the collected web site suspected to be a black market and searches, in steps, the structure of the app market site configured in order of a category level, an app information list level and an app download level through an HTML analysis.

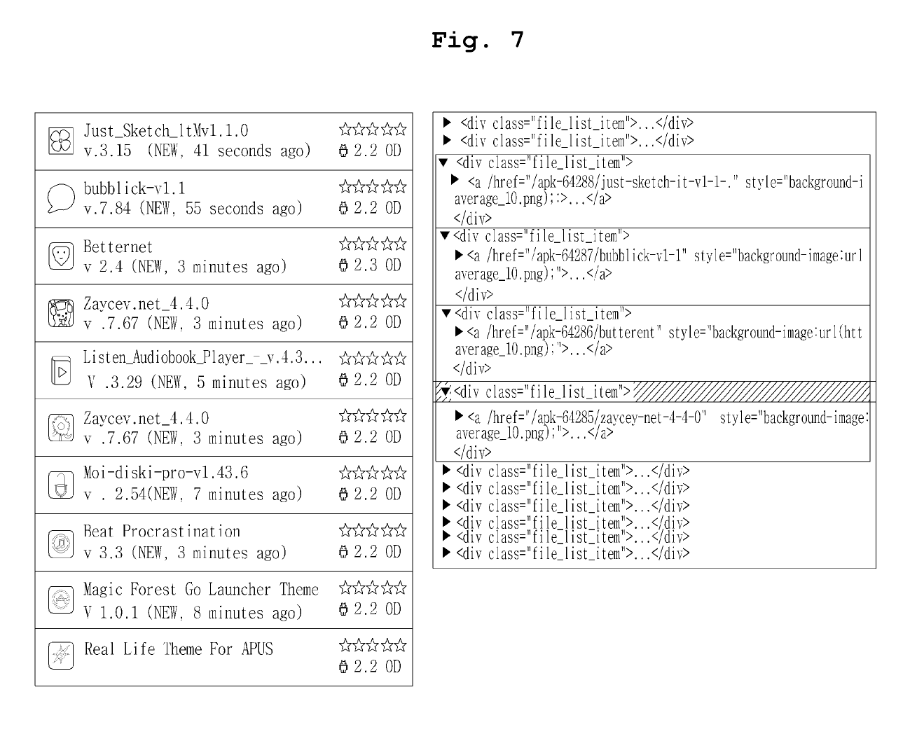

The URL pattern analysis unit 310 confirms whether or not a parent tag (e.g., the category, the app information list, the app download or the like) matches by parsing the search result using the ‘class’ name of ‘div’ tag as shown in FIG. 7. FIG. 7 is an exemplary view showing a pattern analysis using ‘div class’ tag of the present invention.

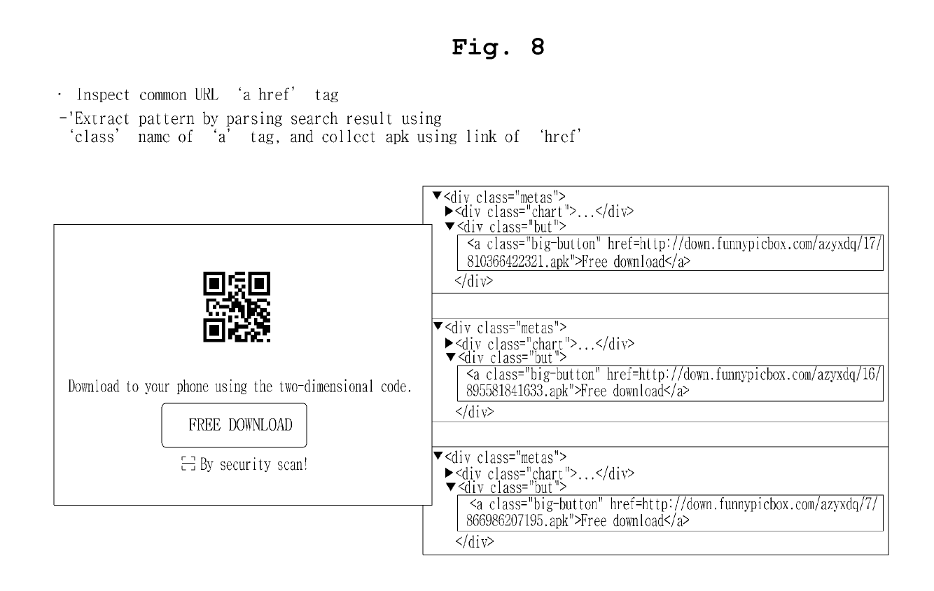

Then, as shown in FIG. 8, the URL pattern analysis unit 310 analyzes a common URL of ‘a href’ tag by parsing the search result using the ‘class’ name of the ‘a’ tag.

The URL pattern analysis unit 310 extracts a pattern of the path reaching the ‘app download’ level and collects various kinds of apk files using the links of the ‘href’ tags. FIG. 8 is an exemplary view showing a pattern analysis using ‘a class’ tag of the present invention.

When search of the URL pattern analysis unit 310 does not reach the ‘app download’ level yet, the URL history creation unit 330 creates a path history reaching the current level (or updates a previously created path history).

If a ‘href’ tag related to an apk file is detected and it is determined that search of the URL pattern analysis unit 310 has reached the ‘app download’ level as a result of the search as shown in FIG. 8, the apk collection unit 320 downloads the corresponding app (e.g., an apk file).

If it is determined that search of the URL pattern analysis unit 310 has reached the ‘app download’ level, the collection pattern rule creation unit 340 creates a rule related to the apk collection pattern as shown in FIG. 9 with reference to the path history of the URL history creation unit 330.

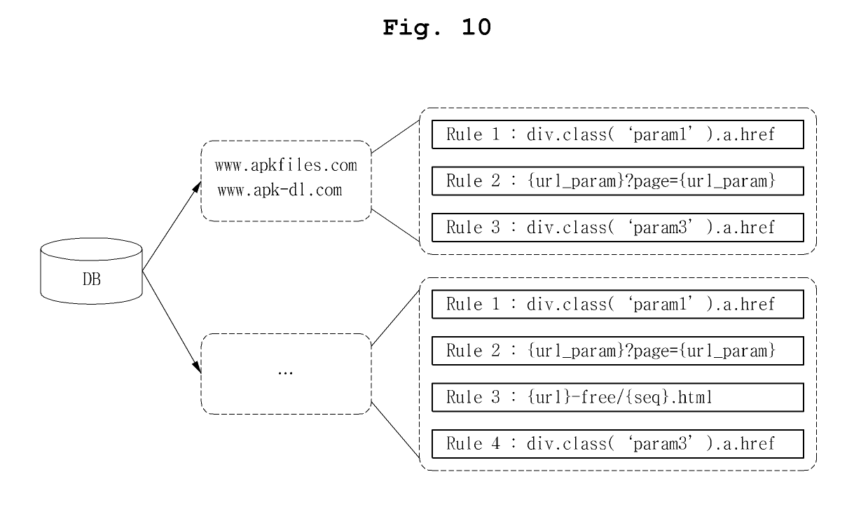

As shown in FIG. 10, the collection pattern rule creation unit 340 categorizes black markets to which the same pattern rule is applied in groups and stores them in the database 400.

When a different type of apk collection rule is formed for each black market, the collection pattern rule creation unit 340 categorizes black markets having a similar or the same apk collection patter rule in groups and stores them in the database 400. FIG. 10 is a view showing an apk collection pattern rule of each black market group.

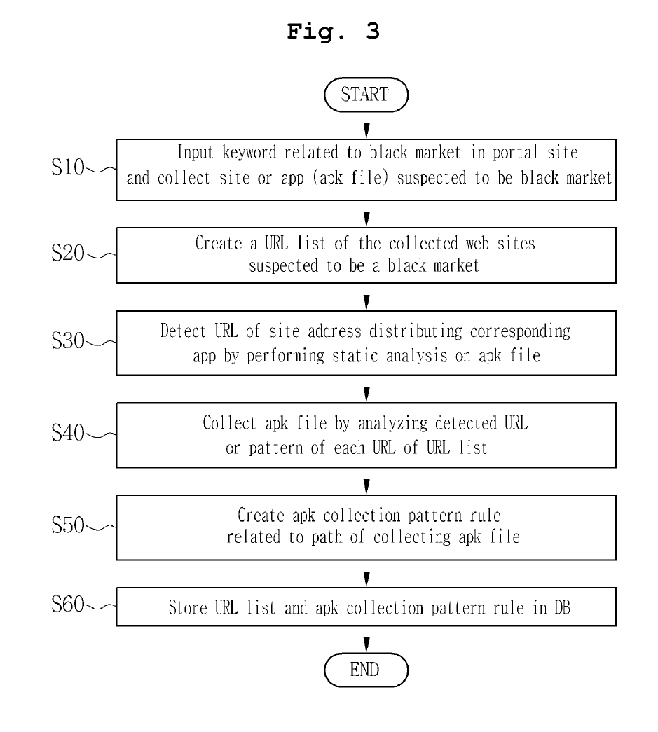

FIG. 3 is a flowchart illustrating a black market collection method according to the present invention.

As shown in FIG. 3, the black market collection system according to the present invention first collects web sites suspected to be a black market or apk files suspected to be a black market app by means of a search related to the black market through portal sites. Then, the black market collection system creates a URL list of the collected web sites suspected to be a black market (step S10 and S20).

When the black market sites are collected, if a user inputs a search keyword related to black market sites through the Open API of the portal sites and a search result corresponding thereto is output, the system parses the search result and creates information on the Uniform Resource Locator (URL) list as shown in FIG. 4.

Then, if a specific apk file exists in the URLs secured through the search, the system detects URL information by performing a static analysis on the corresponding apk file (step S30). If a specific apk file exists in the URLs secured through the search, the black market collection system obtains a source code by decompiling the specific apk file and detects a URL of a site distributing a corresponding app.

The black market collection system converts the binary code of the apk file into a source code by performing decompilation and detects a string of a site address distributing the apk file from the converted source. Then, the black market collection system creates a URL address of a corresponding site by reconfiguring the detected string into a form conforming to the URL format.

Then, the black market collection system collects apk files by analyzing the URL list or URL patterns of the URLs detected in step S30 and creates an apk collection pattern rule related to the paths of collecting the apk files (steps S40 and S50).

The black market collection system visits a corresponding web site with reference to the URLs in the URL list or the URLs detected in step S30 and searches, in steps, the structure of the app market site configured in order of a category level, an app information list level and an app download level through an HTML analysis. The system creates a path history in the process of searching the structure of the visited site. Then, if search of the system reaches the ‘app download’ level, the system creates a rule related to the apk collection pattern as shown in FIG. 9 with reference to the path history.

Then, the system stores the created apk collection pattern rule in the database 400 together with the list of the collected URLs (step S60).

The black market collection system according to the present invention can be implemented in a recording medium that can be read by a computer using software, hardware or a combination of these.

According to hardware implementation, the black market collection system described herein can be implemented using at least one of application specific integrated circuits (ASICs), digital signal processors (DSPs), digital signal processing devices (DSPDs), programmable logic devices (PLDs), field programmable gate arrays (FPGAs, processors, controllers, micro-controllers, microprocessors, and electric units for performing a function. In some cases, the embodiments described in this specification can be implemented as the black market collection system itself.

Although the present invention has been described with reference to the embodiment(s) shown in the figures, those skilled in the art may make various modifications therefrom and understand that all or some of the embodiments described above may be selectively combined and configured. Therefore, the true technical protection scope of the present invention will be defined by the technical spirit of the appended claims.

As described above, the present invention implements a black market site collection system for determining a black market site by analyzing URLs expected to be a market site or apk files expected to be a market app based on a search result obtained through portal sites (e.g., Google, Naver, Daum and the like).

The present invention proposes a technique of collecting black markets based on search keywords. Through the black market site collection method, the present invention is expected to collect black markets and continuously monitor whether or not malware is distributed.

What is claimed is:

1. A black market collection system for tracing distributors of mobile malware, the system comprising:
a black market collection module for collecting web sites suspected to be a black market or apk files suspected to be a black market app by means of a search related to black markets through portal sites, and creating a URL list of the collected web sites suspected to be a black market;
an app static analysis module for obtaining a source code by decompiling the collected apk file and detecting a URL of a site address distributing a corresponding app;
a site analysis module for collecting apk files by analyzing the URLs detected by the app static analysis module or each URL pattern of the URL list and creating an apk collection pattern rule related to paths of collecting the apk files; and
a database for storing the URL list of the collected web sites suspected to be a black market and the created apk collection pattern rule.

2. The system according to claim 1, wherein the app static analysis module includes:
a decompiler for obtaining the source code by decompiling the collected apk file;
a string detection unit for detecting a string of a site address distributing the apk file from the source code; and
a regular expression unit for creating a URL address of a corresponding site by combining the detected string.

3. The system according to claim 1, wherein the site analysis module includes:
a URL pattern analysis unit for visiting a corresponding web site according to the URL of the collected web site suspected to be a black market and searching, in steps, a structure of an app market site configured in order of a category level, an app information list level and an app download level through an HTML analysis;
a URL history creation unit for creating a path history reaching a current level when the search does not reach the ‘app download’ level yet as a result of the search performed by the URL pattern analysis unit;
an apk collection unit for downloading a corresponding app if it is determined that the search of the URL pattern analysis unit has reached the ‘app download’ level as a result of the search; and
a collection pattern rule creation unit for creating a rule related to an apk collection pattern with reference to the path history if it is determined that the search of the URL pattern analysis unit has reached the ‘app download’ level.

4. A black market collection method for tracing distributors of mobile malware, the method comprising the steps of:
collecting web sites suspected to be a black market or apk files suspected to be a black market app by means of a search related to black markets through portal sites;
creating a URL list of the collected web sites suspected to be a black market;
detecting a URL of a site address distributing a corresponding app by performing a static analysis on the collected apk file, by an app static analysis module;
collecting apk files by analyzing the URLs detected by the app static analysis module or each URL pattern of the URL list, by a site analysis module;
creating an apk collection pattern rule related to a path of collecting the apk file; and
storing the URL list of the collected web sites suspected to be a black market and the created apk collection pattern rule in a database.

5. The method according to claim 4, wherein the URL detection step of the app static analysis module includes the steps of:
obtaining a source code by decompiling the collected apk file;
detecting a string of a site address distributing the apk file from the source code; and
creating a URL address of a corresponding site by combining the detected string.

6. The method according to claim 4, wherein the step of creating an apk collection pattern rule includes the steps of:
visiting a corresponding web site according to the URL of the collected web site suspected to be a black market and searching, in steps, a structure of an app market site configured in order of a category level, an app information list level and an app download level through an HTML analysis, a URL pattern analysis unit;
creating a path history reaching a current level when the search does not reach the ‘app download’ level yet as a result of the search performed by the URL pattern analysis unit, by a URL history creation unit;
downloading a corresponding app if it is determined that the search of the URL pattern analysis unit has reached the ‘app download’ level as a result of the search, by an apk collection unit; and
creating a rule related to an apk collection pattern with reference to the path history if it is determined that the search of the URL pattern analysis unit has reached the ‘app download’ level, by a collection pattern rule creation unit.
